(19) United States
(12) Patent Application Publication
(10) Pub. No.: US 2016/0041024 A1
(43) Pub. Date: Feb. 11, 2016

(54) THROUGH-WALL TANK ULTRASONIC TRANSDUCER

(71) Applicant: SSI TECHNOLOGIES, INC., Janesville, WI (US)

(72) Inventors: Lawrence B. Reimer, Georgetown, SC (US); Gregory P. Murphy, Janesville, WI (US)

(21) Appl. No.: 14/456,209

(22) Filed: Aug. 11, 2014

(51) Int. Cl. G01F 23/296

(52) U.S. Cl. CPC G01F 23/296

(57) ABSTRACT

Technology is described for tank coupled to an ultrasonic sensor subassembly where the combination of the tank and ultrasonic sensor subassembly for an ultrasonic sensor. In an embodiment, ultrasonic sensor subassembly is configured to form an ultrasonic sensor upon coupling to a tank having a tank wall. The ultrasonic sensor subassembly includes a sensor subassembly housing, a planar piezoelectric element located within the sensor subassembly housing, and a circuitry electrically connected to the planar piezoelectric element, where the planar piezoelectric element includes a surface coupled to the tank wall such that the tank wall forms a matching layer of an ultrasonic sensor, and the circuitry configured to produce a signal to drive the planar piezoelectric element to generate a sound wave, and receive an indication of a detected echo from the planar piezoelectric element. Various other methods and systems are also disclosed.

### BACKGROUND

A transducer is a device that converts energy from one form (e.g., electrical) to another (e.g., mechanical). Transducers are used in a variety of automotive, commercial, and industrial applications. Ceramic crystals are used as transducers in ultrasonic devices or sensors. The crystals convert an electrical input into sound waves. Ultrasonic devices can use the piezoelectric effect to measure changes in pressure, acceleration, strain or force by converting these changes to an electrical charge. Ultrasonic devices (e.g., ultrasonic sensors or piezoelectric transducers) can be used in various applications, such as medical imaging, non-destructive testing, or distance and level sensing applications.

In ultrasonic level sensing as used with a tank of fluid, a typical level sensor is designed and built as a self-contained unit and assembled through an opening in the wall of a tank or combined with some other component, such as a fuel module, which is also assembled through an opening in the wall of the tank. Other typical level sensors may be self-contained units and assembled within the tank. Depending on the type of level sensor, the level sensor is either immersed within the fluid or resides in the airspace located directly above the fluid.

### SUMMARY

Embodiments of the invention relate to an ultrasonic sensor formed by a tank (e.g., automotive fuel tank) coupled to an ultrasonic sensor subassembly. Various systems and methods are described for coupling (e.g., bonding) the tank to the ultrasonic sensor subassembly, testing the coupling of the tank to the ultrasonic sensor subassembly and the ultrasonic sensor, and programming the ultrasonic sensor for a specified tank design and type of fluid being measured.

In one embodiment, the invention provides ultrasonic sensor subassembly configured to form an ultrasonic sensor upon coupling to a tank having a tank wall. The ultrasonic sensor subassembly includes a sensor subassembly housing, a planar piezoelectric element located within the sensor subassembly housing, and circuitry electrically connected to the planar piezoelectric element. The planar piezoelectric element includes a surface configured to couple to the tank wall such that the tank wall forms a matching layer of the ultrasonic sensor. The circuitry is configured to produce a signal to drive the planar piezoelectric element to generate a sound wave and receive an indication of a detected echo from the planar piezoelectric element.

The surface of the planar piezoelectric element can be coupled or bonded to the tank wall using an adhesive. The tank can be configured for a motorized vehicle or equipment, such as a motor vehicle (e.g., motorcycles, cars, automobiles, trucks, buses, trains), watercraft (ship or boat), aircraft, or spacecraft. The tank can be used to contain various types of fluids, such as fuel, gasoline, diesel, oil, coolant, diesel exhaust fluid (DEF), brake fluid, transmission fluid, windshield washer fluid, water (e.g., fresh water, gray water, or black water), or any other fluid needing a continuous level measurement. The ultrasonic sensor and tank can be well suited to high volume production used in motorized vehicles and equipment.

The circuitry of the ultrasonic sensor subassembly can include a printed circuit board (PCB) or a system on chip (SoC). The circuitry can be configured to test or verify the coupling between the tank wall and the planar piezoelectric element of the ultrasonic sensor. The circuitry can also be configured to extrapolate a fluid level for a specified tank design and a type of fluid being measured or determine a concentration of the fluid using a strapping table that maps an output (e.g., a detected echo of a sound wave) from the ultrasonic sensor against a predefined table of values. The circuitry and sensor can provide a level indication proportional to the volume of fluid remaining within the tank or an actual level measurement depending on the original equipment manufacturer (OEM) implementation. The ultrasonic sensor can be configured to measure a fluid concentration or a fluid level.

The ultrasonic sensor subassembly can also include a temperature sensor electrically connected to the circuitry configured to detect a temperature of a fluid in the tank. The temperature of the fluid sensed by the temperature sensor can be an input to the strapping table to extrapolate a fluid level for a specified tank design and a type of fluid being measured or determine a concentration of the fluid. For example, a processor can use the temperature values and time of flight values as the variables for strapping a table and generate a fluid level either as a volume of fluid remaining or an actual level measurement. The ultrasonic sensor subassembly can include an integral connector or a wire harness electrically coupled to the circuitry to provide a connector or interface to an external computing device (e.g., a testing device or a programming device) for testing the ultrasonic sensor or programming the circuitry. The testing device can be configured to test the ultrasonic sensor formed by a combination of the ultrasonic sensor subassembly and the tank wall. The programming device can be configured to program the circuitry of the ultrasonic sensor subassembly with a strapping table that maps an output from the time of flight measurement from the ultrasonic sensor and temperature against a predefined table of values to extrapolate a fluid level for a specified tank design and/or a type of fluid being measured.

The ultrasonic sensor subassembly can include various other components. For example, the planar piezoelectric element can have a matching layer on both planar surfaces. The matching layers (e.g., a first matching layer) can be used to match an acoustical impedance of the planar piezoelectric element to the tank wall. Thus, a second matching layer can be coupled to a surface of the planar piezoelectric element opposite the surface that is configured to be coupled to the tank wall, where the tank wall provides a first matching layer. The ultrasonic sensor subassembly can also include leads electrically coupling each planar surface of the planar piezoelectric element to the circuitry, and a piezo potting material to support the leads or movement of the planar piezoelectric element in the sensor subassembly housing. A cover can be used to protect the circuitry and the planar piezoelectric element of the ultrasonic sensor subassembly from external environmental conditions, and a printed circuit board (PCB) potting material can be used to support or protect the circuitry and other components in the ultrasonic sensor subassembly.

In another embodiment, the invention provides a tank coupled to an ultrasonic sensor subassembly. The tank has a tank wall configured to be coupled to the ultrasonic sensor subassembly. An ultrasonic sensor is formed by the coupling of the ultrasonic sensor subassembly with the tank wall of the tank. The ultrasonic sensor subassembly includes a sensor subassembly housing, a planar piezoelectric element located within the sensor subassembly housing, and circuitry electrically connected to the planar piezoelectric element. The planar piezoelectric element includes a surface coupled to a tank wall such that the tank wall forms a matching layer of the ultrasonic sensor. The circuitry is configured to produce a signal to drive the planar piezoelectric element to generate a sound wave and receive an indication of a detected echo from the planar piezoelectric element. The detected echo is the sound wave that is reflected off the surface of the fluid within the tank.

The tank wall forms a sensor subassembly receptacle to mate with the sensor subassembly housing and aligns the tank wall with the surface of the planar piezoelectric element. The sensor subassembly receptacle can include a mechanism to fasten the sensor subassembly housing to the tank. For example, the fastener can include a snapping mechanism, a clasp, a latch, or other attachment mechanism, where the sensor subassembly receptacle and the sensor subassembly housing have corresponding mating features. The fastener can be used to hold the sensor subassembly housing in position against the tank wall during bonding or curing of the adhesive. The tank can include stiffeners (e.g., stiffening ribs on a perimeter of the sensor subassembly receptacle) to provide a rigid structure for the sensor subassembly receptacle.

The tank wall can include features to enhance the coupling, bond, or bond line between the tank wall and the planar piezoelectric element of the ultrasonic sensor subassembly. For example, the tank wall can be configured to pass ultrasonic energy and include at least three spacers defining a uniform planar surface of the matching layer. The spacers can be configured to maintain a substantially uniform bond line between the planar piezoelectric element and the tank wall. For instance, each spacer can have columnar, pyramidal, or dome-like shape. The substantially uniform bond line can have a substantially constant thickness controlled by a height of the spacers. In one example, the spacers can form a grid and define grid openings for receiving an adhesive for the substantially uniform bond line.

A focus tube can be integrally formed by the tank or included within the tank. A focus tube or measuring tube can extend from a lower wall section of the tank upwards towards an upper wall section of the tank to improve detection of a correct fluid level by the ultrasonic transducer. The height of the focus tube can be dictated by the angle performance requirements of the specific application. For example, the height of the focus tube may not extend all the way to the upper wall and may form a structural element within the tank that is substantially shorter than the distance from the lower wall section of the tank to the upper wall section of the tank. The planar piezoelectric element can be coupled to a surface of the tank wall that is on an opposite side of the tank wall to an area within the focus tube. A plane or a surface formed by an upper end of the focus tube is nonparallel (e.g., angled) with respect to the fluid plane to reduce interference from signals bouncing off the plane or the surface formed by an upper end of the focus tube. The plane formed by an upper end of the focus tube may be open or closed. A focus tube float can be confined by the focus tube to improve reflection of a sound wave generated by the ultrasonic sensor.

In another embodiment the invention provides a method of bonding an ultrasonic sensor subassembly to a tank wall of a tank to form an ultrasonic sensor. The method can include providing the tank, which can be formed using a variety of process, such as blow molding, rotational molding, rotary or roto molding, or injection molding. The method can further include cleaning (e.g., plasma cleaning) a bond line surface of the tank wall or cleaning (e.g., plasma cleaning) the surface of the planar piezoelectric element, where the bond line is the interface between the tank wall and the planar piezoelectric element. The bond line surface of the tank wall can include spacers to provide a substantially constant thickness of the bond line. The can be formed during fabrication of the tank.

The method can further include applying an adhesive to the tank wall or a surface of a planar piezoelectric element located within the sensor subassembly. Then, coupling the surface of the planar piezoelectric element of the ultrasonic sensor subassembly to the tank wall in an area with the adhesive (i.e., bond line) to form an ultrasonic sensor such that the tank wall forms a matching layer of the ultrasonic sensor. The method can further include curing the adhesive (e.g., a polymer) to toughen or harden the adhesive.

The method can provide for testing the ultrasonic sensor to verify a bond between the tank wall and the surface of the planar piezoelectric element. For example, the testing can include coupling the ultrasonic sensor subassembly to a testing device via an integral connector. The testing device can stimulate the ultrasonic sensor to measure the ring time at multiple power levels by sending a message to the ultrasonic sensor for the ultrasonic sensor to enter a self-test mode. Once in the self-test mode the ultrasonic sensor measures the ring time at various power levels and communicates the resulting information to the testing device. The measured ring time responses can be compared against specified threshold values in an acceptance table for a specified tank design to verify that the ring time responses of the ultrasonic sensor fall within the specified threshold values indicating a functioning ultrasonic sensor for the specified tank design. Under damped ring times (i.e., ring times that are too long) or over damped ring times (i.e., ring times that are too short) can cause an ultrasonic sensor to fail a self-test. For example, testing the ultrasonic sensor can be performed without any fluid within the tank. Fluid in the tank can dampen the signals used for testing and shorten expected ring time values, which can reduce the resolution of the measured signals and the testing device's capability to discern good ultrasonic sensors from bad ultrasonic sensors.

The method can provide for programming the circuitry of the ultrasonic sensor subassembly with a strapping table that maps an output from the ultrasonic sensor against a predefined table of values. The strapping table along with the output from the ultrasonic sensor can be used to extrapolate a fluid level for a specified tank design and a type of fluid being measured or extrapolate a fluid concentration. For example, the strapping table can map a type of the fluid, a time of flight as measured from a detected echo return signal, and a temperature of the fluid to create an output value representative of a volume of the fluid or a depth of the fluid remaining within the tank. The planar piezoelectric element, matching layers, a piezo potting material, a tank material, a tank wall thickness, a bond line material, bond line dimensions can be factors in the development of an ultrasonic transducer that can efficiently transmit energy up into the fluid.

Other aspects of the invention will become apparent by consideration of the detailed description and accompanying drawings.

### BRIEF DESCRIPTION OF THE DRAWINGS

FIG. 1 illustrates a cross-sectional view of a through wall ultrasonic tank level measurement system including an ultrasonic sensor subassembly bonded to a vehicle tank.

FIG. 2A illustrates a cross-sectional view of an ultrasonic sensor subassembly including a planar piezoelectric element with a horizontal orientation relative to the ultrasonic sensor subassembly that is configured to bond to a vehicle tank.

FIG. 2B illustrates a cross-sectional view of an ultrasonic sensor subassembly including a planar piezoelectric element with a vertical orientation relative to the ultrasonic sensor subassembly that is configured to bond to a vehicle tank.

FIG. 3A illustrates a cross-sectional view of an ultrasonic sensor subassembly including a horizontally oriented planar piezoelectric element bonded to a tank with specified design.

FIG. 3B illustrates a cross-sectional view of an ultrasonic sensor subassembly including a horizontally oriented planar piezoelectric element bonded to a tank with another specified design.

FIG. 3C illustrates a cross-sectional view of an ultrasonic sensor subassembly including a horizontally oriented planar piezoelectric element relative to the ultrasonic sensor subassembly where ultrasonic sensor subassembly is bonded to a tank with another specified design in a vertical orientation.

FIG. 3D illustrates a cross-sectional view of an ultrasonic sensor subassembly for level sensing that includes a vertically oriented planar piezoelectric element relative to the ultrasonic sensor subassembly where ultrasonic sensor subassembly is bonded to a tank with coin slot formed in a bottom of the tank.

FIG. 3E illustrates a cross-sectional view of an ultrasonic sensor subassembly for concentration sensing that includes a vertically oriented planar piezoelectric element relative to the ultrasonic sensor subassembly where ultrasonic sensor subassembly is bonded to a tank with coin slot formed in a bottom of the tank.

FIG. 4A illustrates a partial cross-sectional view of bond line surface on a tank wall of a tank.

FIG. 4B illustrates an enlarged, partial cross-sectional view of bond line surface in a tank wall.

FIG. 5A illustrates a cross-sectional view of bond line surface in a tank wall with pyramidal shaped spacers coupled to a planar piezoelectric element.

FIG. 5B illustrates a cross-sectional view of bond line surface in a tank wall with columnar shaped spacers coupled to a planar piezoelectric element.

FIG. 5C illustrates a cross-sectional view of bond line surface in a tank wall with pyramidal shaped spacers coupled to a planar piezoelectric element.

FIG. 5D illustrates a cross-sectional view of bond line surface in a tank wall with columnar shaped spacers coupled to a planar piezoelectric element.

FIG. 5E illustrates a cross-sectional view of bond line surface in a tank wall with circular shaped spacers coupled to a planar piezoelectric element.

FIG. 6 is flowchart illustrating a process to bond an ultrasonic sensor subassembly to a tank wall of a tank to form an ultrasonic sensor and testing and programming the ultrasonic sensor.

FIG. 7 is flowchart illustrating an example of a method for bonding an ultrasonic sensor subassembly to a tank wall of a tank to form an ultrasonic sensor.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. The same reference numerals in different drawings represent the same element. Numbers provided in flow charts and processes are provided for clarity in illustrating steps and operations and do not necessarily indicate a particular order or sequence. As used herein the term “or” can refer to a choice of alternatives (e.g., an exclusive or) or a combination of the alternatives (e.g., and/or).

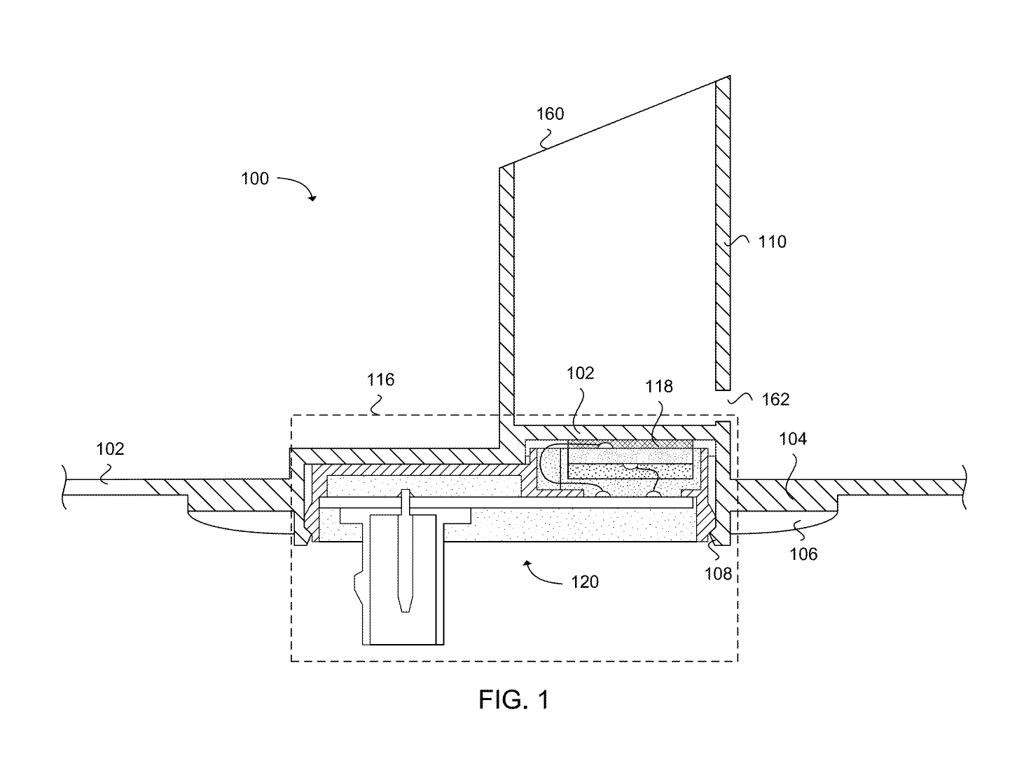

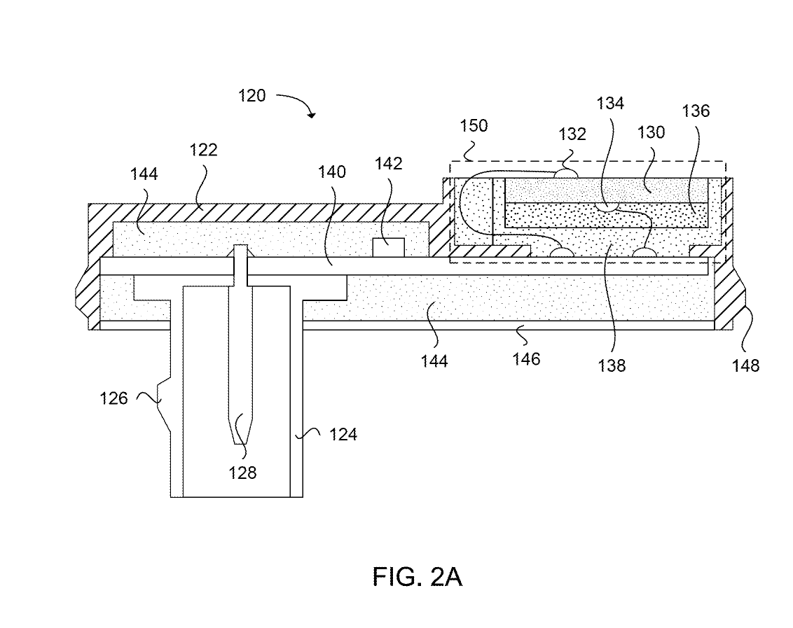

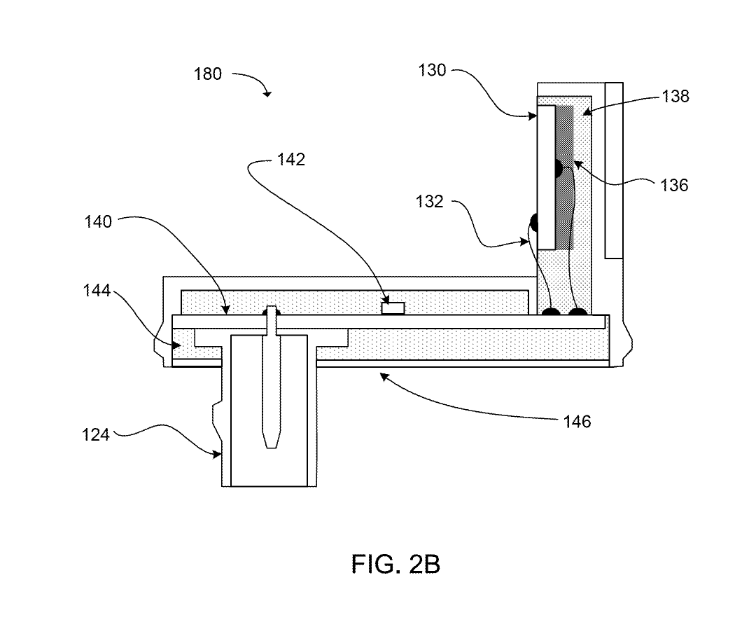

Embodiments of the invention relate to an ultrasonic sensor formed by a tank coupled to an ultrasonic sensor subassembly. For example, as illustrated in FIGS. 1 and 2, an ultrasonic sensor subassembly (S/A) 120, such as an ultrasonic level sensor subassembly, can be bonded onto the bottom of a tank 100 (e.g., automotive fuel tank) without penetrating the wall 102 of the tank. The ultrasonic sensor 116, which includes both the ultrasonic sensor subassembly 120 and the tank wall 102 that acts as a matching layer for a planar piezoelectric element 130 within the ultrasonic sensor subassembly 120, can be used to measure the fluid level (e.g., fuel level) or fluid concentration. The ultrasonic sensor 116 measures the level by broadcasting an ultrasonic signal via a planar piezoelectric element 130 up through the fluid and then measures the time for the signal to return after the ultrasonic signal reflects off the surface of the fluid. In concentration sensing, an ultrasonic signal can be broadcasted in a horizontal path as shown and described in U.S. Pat. No. 8,733,153 to Reimer, entitled “Systems and Methods of Determining a Quality and/or Depth of Diesel Exhaust Fluid,” with a patent date of May 27, 2014, which is herein incorporated by reference in its entirety. Features used to derive fluid concentration in concentration sensing are shown and described in U.S. Pat. No. 7,542,870 to Reimer, entitled “Immersed Fuel Level Sensor,” with a patent date of Jun. 2, 2009, which is herein incorporated by reference in its entirety.

Unless otherwise indicated, the phrases “ultrasonic sensor,” “ultrasonic transducer,” “piezoelectric sensor,” “piezoelectric transducer,” “sensor,” and “transducer,” may be used interchangeably to refer to an ultrasonic sensor 116. Unless otherwise indicated, the phrases “ultrasonic sensor subassembly,” “sensor subassembly,” and “subassembly” may be used interchangeably to refer to an ultrasonic sensor subassembly 120. Unless otherwise indicated, the phrases “ultrasonic sensing system” and “sensing system” may be used interchangeably to refer to an ultrasonic sensing system including the tank, ultrasonic sensor subassembly, and the ultrasonic sensor formed by the tank and ultrasonic sensor subassembly. Unless otherwise indicated, the phrases “piezoelectric element,” “planar piezoelectric element,” or “piezo layer” may be used interchangeably to refer to a piezoelectric element 130. Planar piezoelectric element 130 refers to a configuration of the piezoelectric element allowing a surface to be coupled to a tank 100 and not the orientation of the piezoelectric element relative to the tank. The planar piezoelectric element 130 can be configured in a horizontal orientation, vertical orientation, or some other orientation to the tank 100.

Unlike typical ultrasonic sensors, the ultrasonic sensing system described herein relies on the tank 100 having been constructed with features enabling the attachment of the sensor subassembly 120 and controlling the piezo bond line 118 to insure that the combination of the bond line adhesive, tank material, and dimensions of the assembly create an ultrasonic transducer 116 that is both efficient and will resonate at the natural frequency of the selected piezoelectric material and configuration. The sensor subassembly 120 can include circuitry that allows customization of the sensing system, post assembly (i.e., after assembly), to facilitate different tank sizes, shapes, and application fluids. The circuitry can include hardware, firmware, program code, executable code, computer instructions, and/or software. In addition the sensor subassembly can include self-test circuitry to measure and broadcast application specific measurement data that enables an external test machine or device to evaluate whether the sensing system is operating as intended following assembly into the tank.

The ultrasonic sensing system described herein provides various benefits over typical ultrasonic sensors. For example, typical level sensors are designed and built as a self-contained unit for a specific tank design and assembled through an opening in the wall of a tank or combined with some other component, such as a fuel module, which is in turn assembled through an opening in the wall of the tank. Depending on the technology selected, the level sensor is either immersed within the fluid, resides in the airspace located directly above the fluid or both. Several disadvantages are associated with the typical ultrasonic sensor within the tank. For instance, the typical ultrasonic sensor has to be uniquely designed and calibrated for each different tank design into which the sensor is being assembled, which can create a proliferation of different parts, different part numbers, assembly processes that can increase costs. The typical ultrasonic sensor within a tank is either exposed to the fluid or fluid vapors, which can be corrosive to the sensor that can create challenges with reliability and increased cost depending on the fluid being measured. In addition, the tank for a typical ultrasonic sensor has to have an opening in one of the tank walls from which to assemble the sensor or larger module including the sensor. The opening can create a potential leak path for the fluid or vapor emissions. In the case of an automotive gasoline tank in the United States (US), evaporative emissions is regulated by the Environmental Protection Agency (EPA) resulting in an increased governmental standards and regulations to insure that the resulting tank designs are leak tight. Other countries may have similar governmental or administrative agencies (similar to the EPA in the US) to regulate fluid or vapor emissions and protect the environment.

Alternatively, a self-contained ultrasonic sensor may be arranged on the outside of the tank using a semisolid contact material (e.g., grease or ultrasonic gel), an elastomer, or an adhesive. These through wall ultrasonic sensors can use point level devices attached to the side of the tank visa via the contact material, elastomer, or adhesive. In these through wall sensor applications, the self-contained sensors are calibrated after being assembled to the tank to identify the ultrasonic signature difference when fluid is present or not in the tank on the opposite side of the tank wall opposing the point level sensor. The calibration of these self-contained sensors on the tank wall requires that the tank to be filled with fluid. These point level devices can detect a discrete state of the fluid, such as empty or possibly full, but unfortunately these point level devices do not have the sensitivity or granularity to detect a continuous level reading from a full tank condition to an empty tank condition.

For example, a self-contained ultrasonic sensor is attached outside of the tank (e.g., to the bottom of a tank) with contact material (e.g., ultrasonic gel) between the self-contained ultrasonic sensor and the tank wall. The gel allows at least a portion of the sound energy to be passed through the tank wall, but the tank wall is not part of the resonant system. Ultrasonic gels are commonly available for making ultrasound scans.

In another ultrasonic sensor configuration, the housing features of an ultrasonic sensor 116 (e.g., a level sensor) can be replicated in the wall 102 of a tank 110. Then, the components of the ultrasonic sensor 116, such PCB 140, piezoelectric material or plate 130, piezo potting 138, PCB potting 144, connector 124, 126, and 128, terminals and the like, can be assembled into the wall 102 of the tank 100 where the tank 100 is used as the primary substrate or housing for the ultrasonic sensor 116. Unfortunately, the processes and equipment for manufacturing and assembling the ultrasonic sensor 116 differ from the processes and equipment for molding and assembling the tank 100. The assembly of the individual components of the ultrasonic sensor into the wall of a tank can require equipment and technical expertise not typically used by tank manufacturers. The assembly of the individual components of the ultrasonic sensor 116 into the wall 102 of a tank 100 may be used in a one off or low volume production environment, but may not be economical or logistically feasibly for large volumes, such as scenarios where different tank designs are manufactured at various locations in the world by those skilled in molding and assembling tanks and ultrasonic sensors are manufactured in another location in the world by those skilled in assembling ultrasonic sensors. Conversely, creating a sensor manufacturing process uniquely tailored for each tank molding site can require too much investment per unit of production due to the diversity of tank designs and relatively low volumes produced for each tank design.

Another challenge with this approach of assembling the individual components of the ultrasonic sensor 116 into the wall 102 of a tank 100 is that the tank wall thickness, which is a function of the process being employed, may not be particularly well controlled (e.g., have large tolerances). The tank wall thickness may vary generating changes in the functionality of the sensor 116, which can produce erroneous readings in the fluid levels (or fluid concentrations).

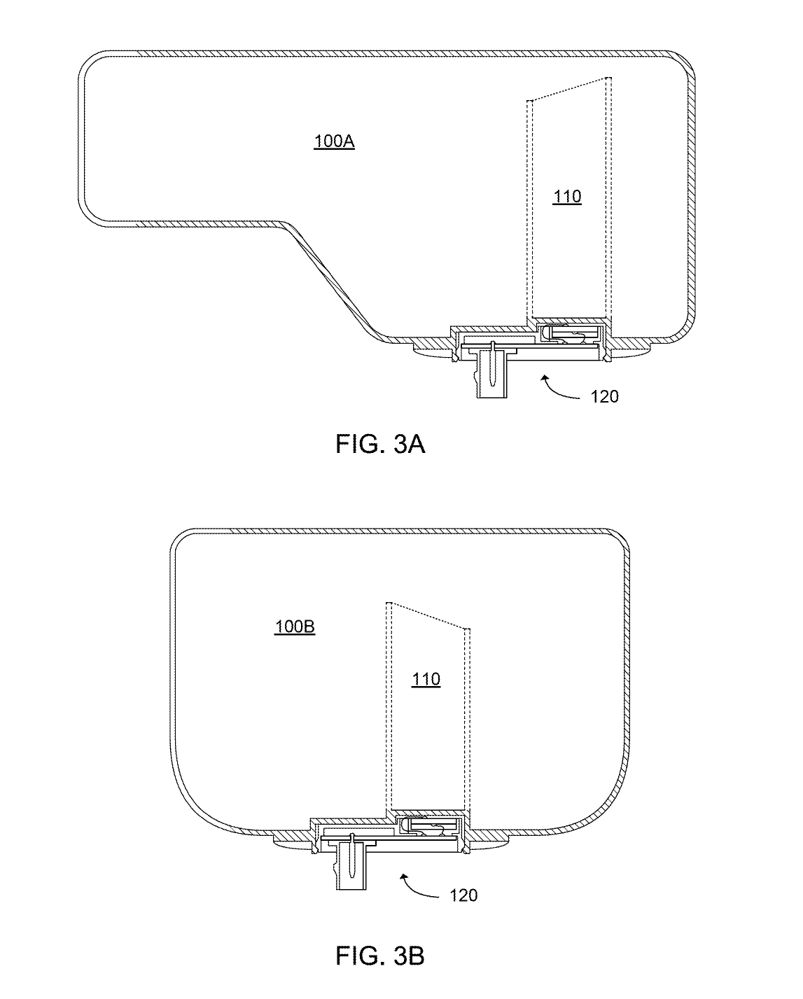

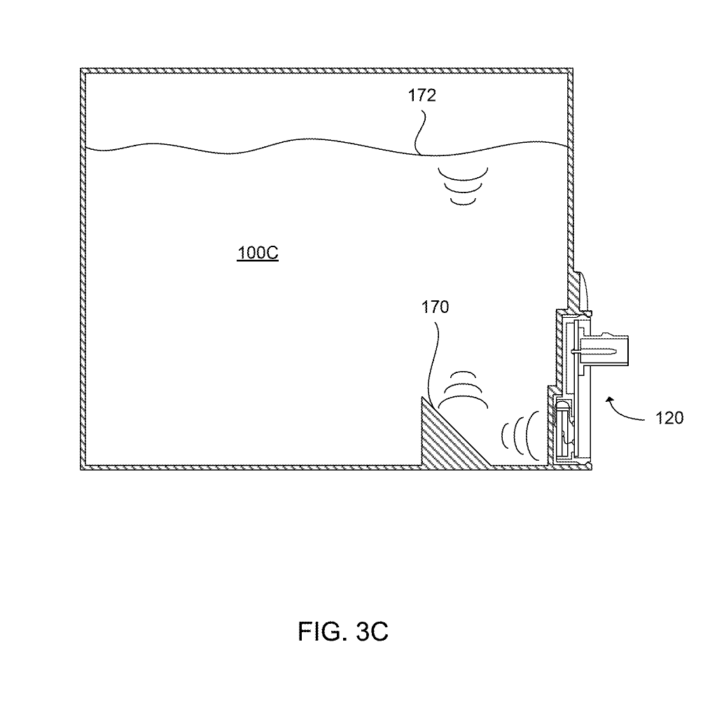

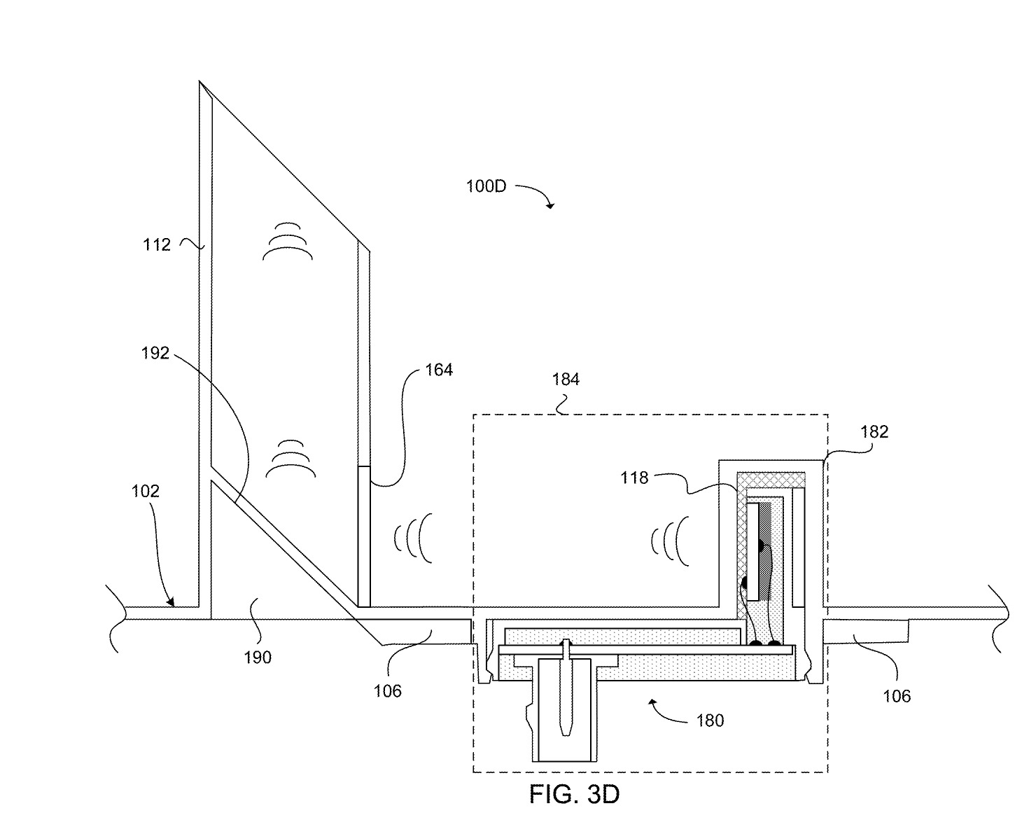

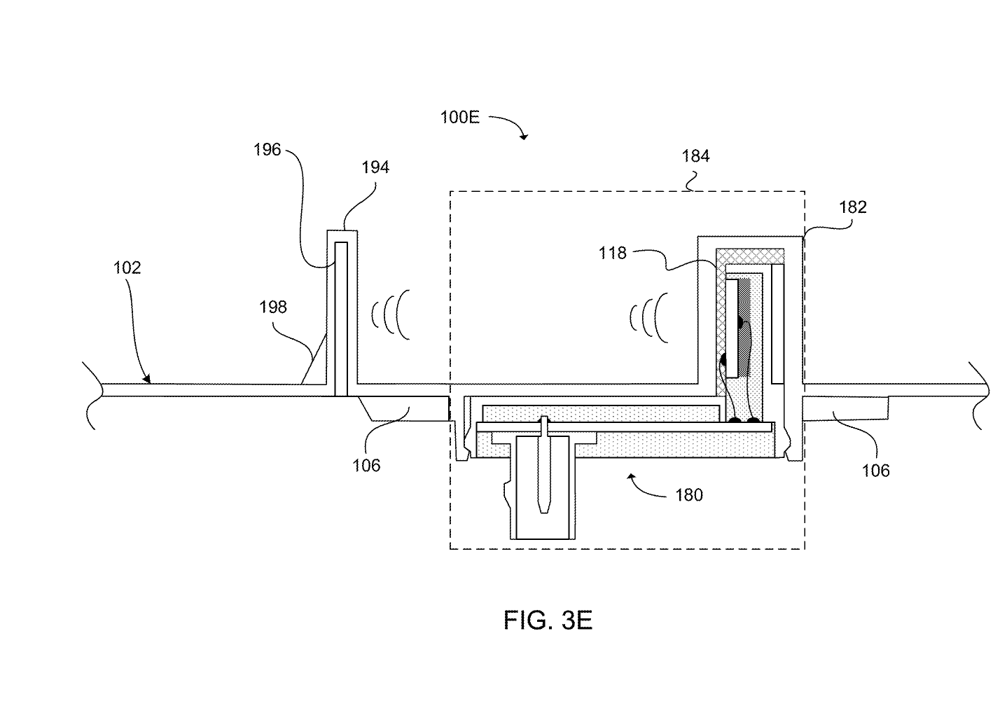

The ultrasonic sensing system described herein overcomes many of these challenges associated with in-tank ultrasonic sensors, self-contained ultrasonic sensors arranged outside the wall of the tank, and the assembling of the individual components of the ultrasonic sensor into the wall of a tank. In an embodiment, the ultrasonic sensing system described applies a common ultrasonic sensor design that can be deployed across multiple tank designs 100A (FIG. 3A), 100B (FIG. 3B), 100C (FIG. 3C), 100D (FIG. 3D), and 100E (FIG. 3E) by simplifying the assembly process of the ultrasonic sensor components to the tank.

The ultrasonic sensing system described herein can have various features. For example, the ultrasonic sensing system creates a resonant ultrasonic transducer where the tank wall 120 forms an integral part of the transducer 116 once the sensor subassembly 120 is affixed to the tank 100. The sensor subassembly 120 may be attached to the tank 100 in such a way that the complete ultrasonic sensing system can be assembled on site at a tank molder's manufacturing facility with the minimum of equipment, tooling, and technical known how. The ultrasonic sensor design can be created independent of a tank's shape or the fluid selected for the tank 100. Following assembly of the ultrasonic sensor 116, the ultrasonic sensor can be customized or programmed for a particular tank shape and fluid contained by the tank 100. Because the ultrasonic sensor 116 can be assembled at a facility other than the site used to manufacture the ultrasonic sensor subassembly 120, the ultrasonic sensor 116 can perform a self-test function to determine whether the ultrasonic sensor 116 functions correctly indicating that the sensing system was assembled and cured correctly.

As illustrated in FIGS. 2A-2B, the sensor subassembly 120 includes half of the resonant circuit (i.e., a piezo layer 130 and a matching layer 136) used to create an ultrasonic transducer along with other electronics, a temperature sensor 142, and other components to construct a functioning ultrasonic sensing system. A piezo subassembly 150 forming half of the resonant circuit includes the piezo layer 130, piezo potting 138, a subassembly matching layer 136, and piezo leads 132 and 134 coupling surfaces of the piezo layer 130 to the circuitry. The other electronics can include circuitry, such as a PCB 140 and associated components or a system on chip (SoC). The PCB 140 mechanically supports and electrically connects electronic components using conductive tracks, pads and other features etched from conductive (e.g., copper or other metal) sheets laminated onto a non-conductive substrate. The SoC is an integrated circuit (IC) that integrates components of a computer, device, sensor, or other electronic system into a single chip. The circuitry or components can include hardware, firmware, program code, executable code, computer instructions, and/or software. In the case of program code execution on programmable computers, the circuitry may include a computing device, a microcontroller, a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The circuitry may be implemented as a hardware circuit comprising custom very-large-scale integration (VLSI) circuits or gate arrays, off-the-shelf semiconductors such as logic chips, transistors, or other discrete components. The circuitry may also be implemented in programmable hardware devices such as field programmable gate arrays, programmable array logic, programmable logic devices or the like.

The piezo layer 130 may have various orientations relative to the circuitry (e.g., PCB 140) or the ultrasonic sensor subassembly. For example, the surface of the piezo layer 130 configured to couple with the tank wall 102 may be oriented in parallel with a plane of the circuitry (e.g., PCB 140) of the ultrasonic sensor subassembly 120, as illustrated in FIG. 2A. For instance, the surface of the piezo layer 130 configured to couple with the tank wall 102 and the plane of the circuitry of the ultrasonic sensor subassembly 120 may both have a horizontal (FIGS. 3A-3B) or vertical (FIG. 3C) orientation relative to the fluid surface or the tank 100A-C. In another example, the surface of the piezo layer 130 configured to couple with the tank wall 102 may be oriented perpendicular to a plane of the circuitry (e.g., PCB 140) of the ultrasonic sensor subassembly 180, as illustrated in FIG. 2B. For instance, the surface of the piezo layer 130 configured to couple with the tank wall 102 may have a vertical orientation relative to the plane of the circuitry of the ultrasonic sensor subassembly 180, which may have a horizontal orientation relative to the fluid surface or the tank 100D-E (FIGS. 3D-3E), or the surface of the piezo layer 130 configured to couple with the tank wall 102 may have a horizontal orientation relative to the plane of the circuitry of the ultrasonic sensor subassembly 180, which may have a vertical orientation relative to the fluid surface or the tank (not shown).

Referring back to components of the ultrasonic sensor subassembly 120, the temperature sensor 142 (e.g., a thermistor or a thermometer) determines a temperature or a temperature gradient of the subassembly using technologies known in the art. The temperature sensor 142 can be used to determine the temperature of the fluid, which can be used to adjust data generated by the sensor 116.

For example, the temperature of the fluid can be used to correct for a change in the speed of sound, which occurs with changing temperatures. The temperature then becomes an input into a strapping table along with a time of flight (TOF) of a detected echo return signal. The values within the strapping table can be set up during calibration to represent a desired output for a tank size shape and fluid being measured for each specific temperature and time of flight combination. Circuitry and/or software can provide a linear interpolation between strapping table values (e.g., temperature and TOF values) to reduce a size of the strapping table.

As shown in FIGS. 1, 2A, and 2B, the piezo assembly 150, the PCB 140 including sensor circuitry and PCB potting 144, and a connector 124, 126, and 128 to couple the sensor circuitry to external devices are assembled into a subassembly housing 122 to form a sensor package (i.e., ultrasonic sensor subassembly 120) that can be readily assembled into the appropriate mating features on a tank 100. The subassembly housing includes a fastener, such as a snapping mechanism 148, a clasp, a latch, threaded mechanism, or other attachment mechanism. The sensor subassembly 120 can be assembled at a sensor fabrication facility while the sensor subassembly 120 can be coupled to the tank 100 at a tank molding facility. The PCB potting 144 is used to protect the PCB 140 from the ambient environment and a protective cover 146 can be added to the sensor subassembly 120 to provide further protection. In an example, the PCB 140 includes a microcontroller and a temperature sensor 142 used to determine a fluid level or a concentration of the fluid and the sensor 116 can be configured and tested through the integral connector 124, 126, and 128. The integral connector 124, 126, and 128 includes a mechanical housing 124 that can be coupled to matching features of a mating connector on the external device or the cable (e.g., coaxial cable) coupling the sensor to the external device. The mechanical housing 124 can also provide an electrical connection (e.g., ground connection) to the sensor circuitry. The integral connector 124, 126, and 128 includes electrical features 128 to provide an electrical connection or a bus connection between the external device and the sensor circuitry. The integral connector 124, 126, and 128 can include a fastener or fastener feature 126 to secure the integral connector to the mating connector. In another embodiment, a wire harness rather than an integral connector 124, 126, and 128 can be coupled to the circuitry to configure, program, or test the sensor 116.

In another embodiment, a wireless component or device coupled to the circuitry may be used to configure and test the sensor 116 using a wireless protocol. The wireless component or device may be powered by a battery or other energy storage device included in the sensor subassembly circuitry, or the wireless component or device can provide two-way communication between the circuitry and the testing device or programming device. The wireless protocol used by the wireless component or device can include any short range or long range wireless protocol, such as the third generation partnership project (3GPP) long term evolution (LTE), the Institute of Electrical and Electronics Engineers (IEEE) 802.16 standard (e.g., 802.16e, 802.16m), which is commonly known to industry groups as WiMAX (Worldwide interoperability for Microwave Access), the IEEE 802.11 standard, which is commonly known to industry groups as Wi-Fi, or Bluetooth. Including the wireless component or device to the sensor subassembly 120 can add cost to the sensor subassembly 120 due to the radio features or energy storage device, but can be used in some applications.

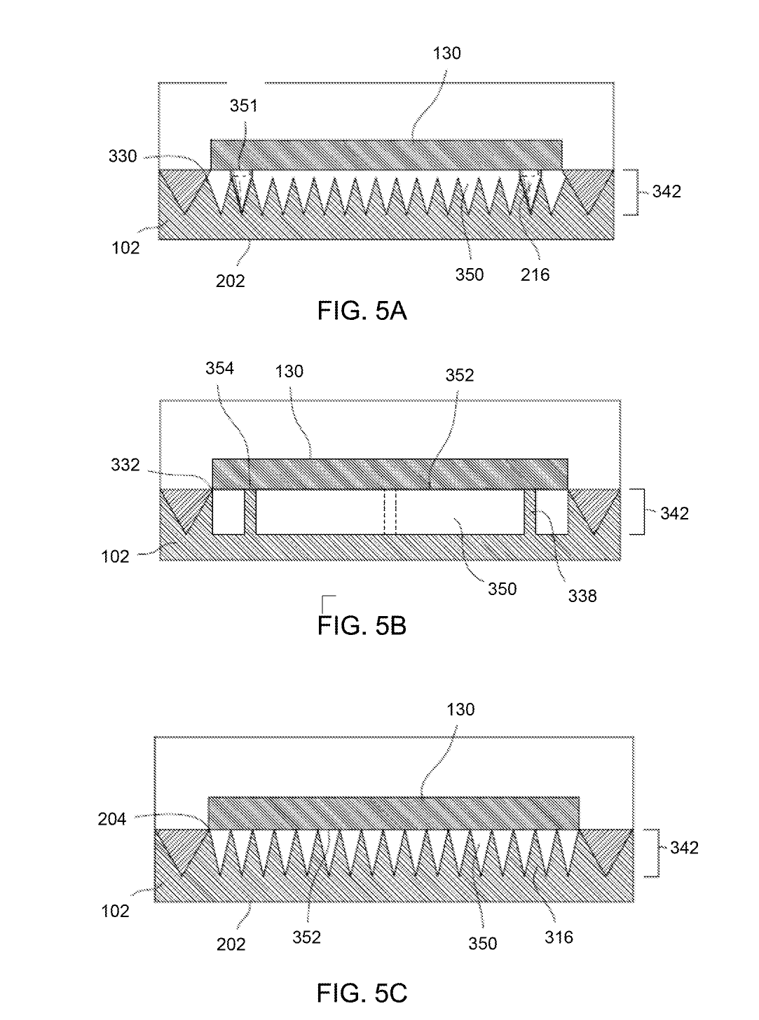

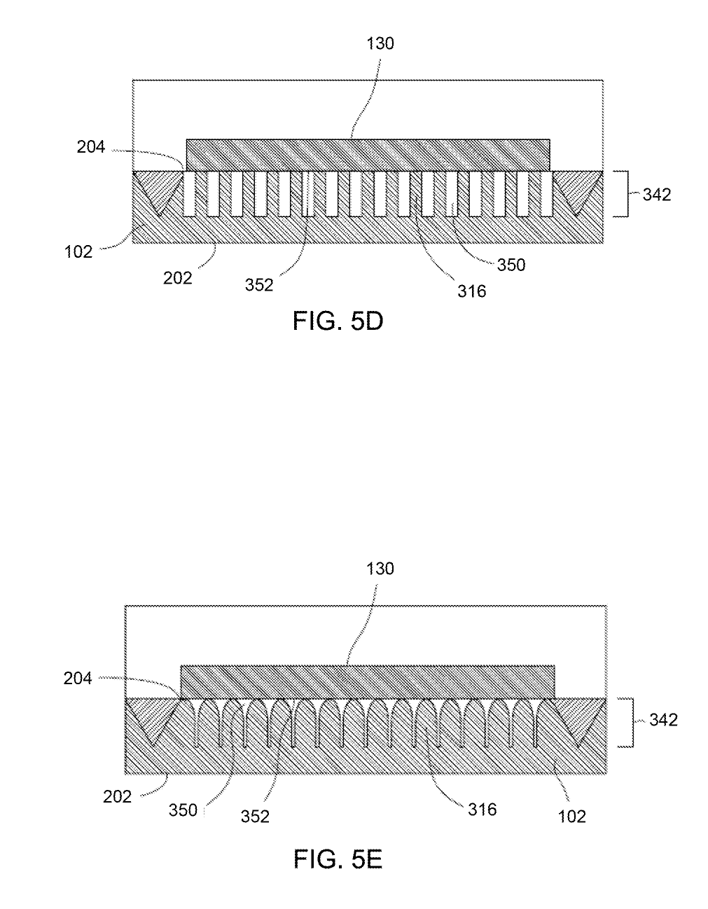

An aspect of an ultrasonic measurement system design that greatly influences the performance of the sensor 116 is the selection of the resonant frequency for operating the ultrasonic sensor 116. Resonance is the tendency of a sensor or system to oscillate with greater amplitude at some frequencies than at others. The materials, thickness, and shape used for the piezo layer 130 and the matching layers 102 and 136 can change the resonant properties of the ultrasonic transducer 116. A first layer matching layer is formed by the tank wall 102 and a second matching layer 136 is present in the subassembly 120. Typical ultrasonic sensor designs start with a piezo layer of a particular thickness and diameter, which in turn dictates a specific operating frequency depending on which mode the piezo layer is vibrating in. Thickness or radial vibration modes are common types of vibration modes for the piezo layer. Once the thickness and diameter of a piezo layer is selected in a typical ultrasonic sensor design, the tank wall thickness between the piezo layer and outside world is selected along with a bond line to create a system that resonates at the selected frequency of operation and maximizes the transmission of ultrasonic energy through the tank wall into the fluid being measured. The bond line 118 is the interface coupling the tank wall 102 to the piezo layer 130 and contributes to the frequency characteristics of the sensor 116. The bond line 118 or 342 (FIGS. 5A-5E) typically includes the adhesive 350 (FIGS. 5A-5E) used to join the tank wall 102 to the piezo layer 130. The tank wall 102, which acts as the first matching layer for the piezo layer 130, can be part of the sensor housing once the subassembly is coupled to the tank 100. The matching layer 136, which can be formed on an opposite surface of the piezo layer 130 from the tank wall 102, is then designed to minimize the ring time and reduce the effect of acoustic interference from waves traveling off the back surface of the piezo in the opposite direction. Ringing is the continued vibration of the piezo layer beyond the electrical excitation pulse.

The ultrasonic sensor 116 described herein separates the sensor subassembly manufacture from the sensor wall fabrication, specifically as the sensor wall fabrication relates to tank wall 102 and tank molding. For instance, the wall thickness of the tank 100 is a function of the tank design and the process employed to construct the tank 100 (e.g., injection molding, blow molding, rotational molding, and similar processes). The bond line dimensions, piezo layer selection, and the matching layer designs are developed around a nominal tank wall thickness rather than finely controlling the tank wall thickness during the tank manufacturing process. An advantage of designing the sensor 116 around the nominal tank wall thickness is that the ultrasonic sensor design accommodates the method of producing the tank 100 rather than changing the method of producing the tank 100 or forcing the tank's production method to yield a result that may not be attainable (e.g., producing tank walls with smaller or tighter tolerances). Thus a common sensor subassembly 120 can be manufactured efficiently in high volume and applied across multiple tank designs significantly reducing manufacturing cost when the method of tank production (e.g., rotary molding or blow molding) is similar across a wide variety of tank sizes and shapes, as illustrated in FIGS. 3A-3E.

Although FIGS. 3A and 3B illustrates an ultrasonic sensor subassembly 120 with the circuitry and the piezo layer 130 (FIG. 2A) oriented horizontally with the tank 100A-B, the ultrasonic sensor subassembly 120 can have any orientation relative to the tank 100 depending on the tank and sensor design. For example, the ultrasonic sensor subassembly 120 with the circuitry and the piezo layer 130 (FIG. 2A) can have a horizontal orientation with the tank 100A-B and can be coupled to a bottom tank wall, as illustrated in FIGS. 3A and 3B, or the ultrasonic sensor subassembly 120 with the circuitry and the piezo layer 130 (FIG. 2A) can have a vertical orientation with the tank 100C and can be coupled to one of the tanks vertical walls, as illustrated in FIG. 3C. For example, the ultrasonic sensor 116 (FIG. 1) in a vertical configuration configured as a level sensor emits a sound wave that initially propagates parallel to the surface of the fluid 172 and then is reflected in the vertical axis by an angled reflector 170 (e.g., 45 degree angled reflector) located a specified distance (e.g., 100 millimeters (mm)) from the ultrasonic sensor 116. The angled reflector 170 can be molded inside of the tank and integrated into the tank 100C or inserted into the tank 100C after the tank 100C is molded. The angled reflector 170 can include materials to redirect the sound wave in the vertical axis. The tank configuration with a vertically oriented ultrasonic sensor 116 (FIG. 1) can be used with focus tube (not shown) or without a focus tube and can have any of the same features described in relation a horizontally oriented ultrasonic sensor 116 (FIG. 1), other than a difference in orientation.

In another configuration, the piezo layer 130 (FIG. 2B) may be oriented vertically relative to the tank while the circuitry (e.g., PCB 140) of the ultrasonic sensor subassembly 180 may be oriented horizontally relative to the tank, as illustrated in FIG. 2B. FIG. 3D illustrates a tank design that includes coin slot like feature 182 molded into the tank 100D to accommodate the horizontally oriented ultrasonic sensor subassembly 180 with the vertically oriented piezo layer 130. The ultrasonic sensor subassembly 180 can be inserted into the bottom of tank 100D and mate with the coin slot like feature 182. As with the other configurations, the piezo bond line 118 can be applied and cured by a tank manufacturer or supplier. The bond line 118 and piezo layer dimensions can be optimized to match the nominal tank wall thickness in the tank wall area around and including the sensor 184. As illustrated in FIGS. 3C-3D, the ultrasonic sensor 116 or 184 used for level sensing emits sound energy parallel to the bottom of the tank 100C-D, which can then be reflected vertically visa via an angled reflector 192. The angled reflector 192 can be formed in the tank wall 102 and form an air pocket 190. In this configuration, the angled reflector (e.g., 45 degree angled wall) provides an acoustic reflector due to the speed of sound difference between the fluid in the tank 100D and the air pocket 190 located directly below the tank wall surface 192. The tank 100C-D may also include a focus tube 112 that can include an opening 164 to allow an ultrasonic signal enter into the focus tube 112 or exit the focus tube 112 without obstruction of the sound wave. The opening 164 may also act as a vent for the focus tube 112 to allow fluid in and out of the focus tube 112.

FIG. 3E illustrates the ultrasonic sensor 184 operating as a concentration sensor used to measure the speed of sound through a fluid, which can be useful for determining the concentration or density of the fluid. Concentration sensors can be used for DEF concentration measurements or measuring the properties of engine oils, fuels and lubricants. Similar to FIG. 3D, FIG. 3E illustrates a tank design that include coin slot like feature 182 molded into the tank 100E to accommodate the horizontally oriented ultrasonic sensor subassembly 180 with the vertically oriented piezo layer 130. A second coin slot like feature 194 can be molded into the tank 100E to provide or accommodate a reflector 196 (e.g., vertical reflector). A metallic reflector 196 may be inserted second coin slot like feature 194, assembled into the bottom of the tank 100E, or integrated into the second coin slot like feature 194 to reflect the sound waves. Alternatively, an air pocket 196 may be formed by second coin slot like feature 194 in the wall 102 of the tank 100E, which may also reflect the sound waves. A stiffener or support feature 198 can be provided additional support and rigidity for the second coin slot like feature 194 and reduce stress on the second coin slot like feature 194. The ultrasonic sensor 184 used for concentration sensing emits sound energy parallel to the bottom of the tank 100E which can then reflect off the reflector 196 located a known distance from the ultrasonic sensor 184. The time the sound wave takes to traverse the distance between the ultrasonic sensor 184 and reflector 196 represents the speed of sound through the fluid, which is proportional to the density of the fluid, which is described in greater detail in U.S. Pat. No. 8,733,153.

The tank design may include additional features to accommodate the sensor subassembly 120. For example, the section of the tank wall that is configured to be coupled to the sensor subassembly 120 can include features to improve the uniformity of the bond line thickness, as shown and described in U.S. Pat. No. 7,176,602 to Schlenke, entitled “Method and Device for Ensuring Transducer Bond Line Thickness,” with a patent date of Feb. 13, 2007, which is herein incorporated by reference in its entirety. Excessive adhesive or bond thickness can adversely affect the characteristics of a transducer or sensor, which can include changing the angle of the piezo layer 130 relative to the tank wall 102. In some applications, the optimum thickness of the adhesive is 0.002″-0.005″. The optimum thickness is based on the specific transducer-to-housing interface 118 (e.g., piezoelectric layer-to-tank wall interface) or bond line 342 (FIGS. 5A-5E). The type of adhesive used for creating the bond line 118 or 342 will vary and is dependent on the specific tank material chosen, although Loctite E120 adhesive has proven to be useful for bonding a ceramic ultrasonic sensor material in a sensor subassembly 120 to a polyethylene tank wall of a tank 100.

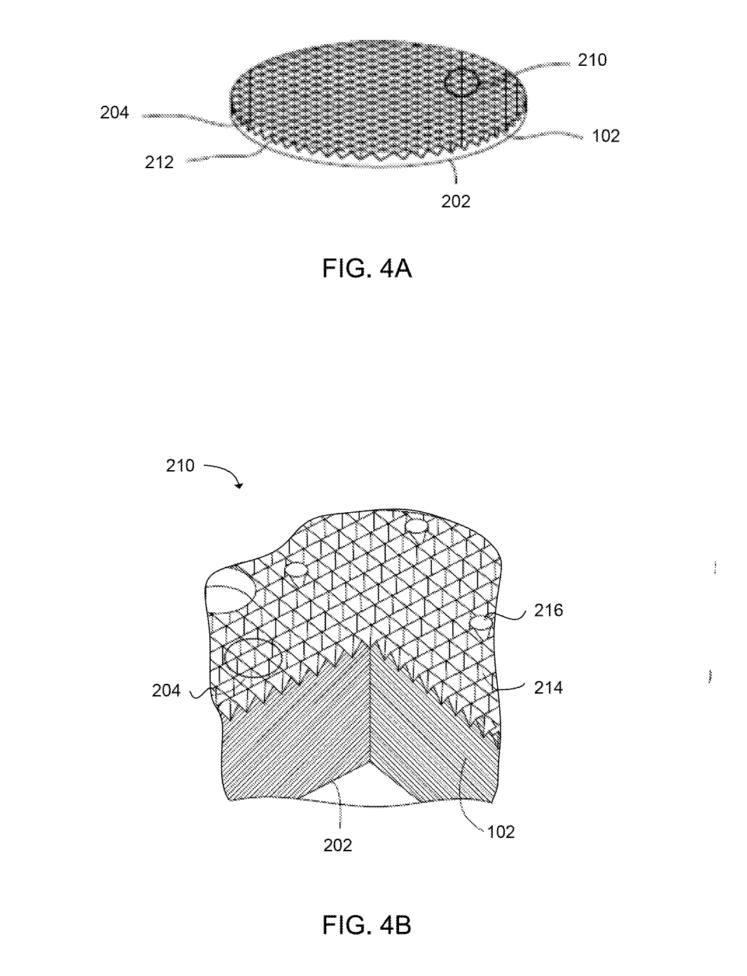

FIG. 4A illustrates partial view of a bond line surface 204 molded (or etched) into a tank wall 102 of a tank 100, and FIG. 4B illustrates an expanded cross-sectional view of the bond line surface 204. The tank wall 102 has an internal surface 202 within the tank and an external surface 204, where external surface 204 can be coupled to the sensor subassembly 120. The external surface 204 configured to be coupled to the sensor subassembly 120 is configured with spacers 212 in a grid pattern 210 that can form part of the bond line. In one example, the external surface can be configured to include at least three spacers 216, where each spacer is positioned in a grid opening, or area, 214.

FIGS. 5A-5E illustrates a variety of shapes for the spacers shown in relation to the piezoelectric layer. The thickness of the bond line 342 is controlled by the height of the spacers. In FIG. 5A, pyramidal features (or spacers) define a first surface 330 of a grid pattern to form openings for the adhesive. Other spacers (taller in height) are conical in shape, wherein the widest, base portion of each spacer 216 defines a second surface 351 upon which the piezo layer 130 is bonded. The piezo layer 130 can be pressed tight to the first surface 351 of the spacers 216. The adhesive 350 provides the bond between the piezo layer 130 and the tank wall 102 in areas 52 where the piezo layer 130 and the tank wall 102 are not in positive contact.

FIG. 5B illustrates an external surface 332 of the tank wall 102 that includes three spacers 338, which are configured to maintain a uniform bond line 342 between the piezo layer 130 and the tank wall 102. The piezo layer 130 is pressed tight to the top surface 354 of the spacers 338. The adhesive 350 provides the bond between the piezo layer 130 and the tank wall 102 in areas 352 where the piezo layer 130 and the tank wall 102 are not in positive contact.

FIGS. 5C, 5D, and 5E illustrate a tank wall 102 that has an external surface 204, an internal surface 202, and a spacer 316 formed by the external surface 204. The spacer 316 is configured in a grid pattern 210 and is configured to maintain a uniform bond line 342 between the piezo layer 130 and the tank wall 102. The grid pattern 210 is configured to maintain uniform spacing between the piezo layer 130 and the tank wall 102, especially when adhesive 350 is applied as a bonding agent. The grid pattern 210 helps ensure a substantially constant-thickness bond line 342. The spacer 316 can be configured in a variety of shapes and may take the form of pyramids (FIG. 5C), columns (FIG. 5D), or domes (FIG. 5E). The piezo layer 130 can be pressed tight to the external surface 204 of the grid pattern 210. The adhesive 350 provides the bond between the piezo layer 130 and the tank wall 102 in areas 352 where the piezo layer 130 and the tank wall 102 are not in positive contact. The adhesive 350 can be applied through a variety manufacturing processes to the grid pattern 210.

The bond line features on the tank wall 102 can be manufactured or etched by the tank manufacturer. The tank manufacturer can also apply the adhesive to the bond line 118 and couple the tank wall 102 with the bond line features to the piezo layer 130 of the sensor subassembly 120 to form an integrated through wall ultrasonic sensor 116.

Referring back to FIGS. 1-3B, the resonant ultrasonic design of the sensor 116 can be developed around the thickness of the tank wall section directly opposite of the piezo layer 130 and the capability of the tank manufacturer to control that dimension and area of the tank wall 102. The combination of the piezo layer 130, a first matching layer formed by the tank wall 102, a second matching layer 136, piezo potting 138, tank material, tank wall thickness, bond line material, and bond line dimensions create a resonant ultrasonic system or sensor, which can be tuned to the natural frequency of the piezo layer 130 when fluid is present within the tank 100. The ultrasonic transducer design takes these factors into consideration and is tuned to optimize the design for the tanks 100 being produced, which can simplify the equipment used by the tank manufacturer to couple the sensor assembly to the tank wall 102 and minimize the expertise and interface used by the tank manufacturer to program and test the ultrasonic sensor 116.

The tank design may also include other additional features to accommodate the sensor subassembly 120. For example, the tank 100 can include a sensor subassembly receptacle formed within the tank wall 120, where the sensor subassembly receptacle includes features that mate with the sensor subassembly. The sensor subassembly receptacle or tank wall 102 in the tank 100 can include features to provide a rigid structure for the sensor subassembly or rigidity in the area surrounding the sensing system (i.e., sensor subassembly 120), such as thicker tank walls 104, stiffing ribs 106, or similar features. The additional rigidity serves to reduce the stress being applied to the bond line 118 and sensor subassembly attachment features when the tank 100 is subjected to extreme overpressure or shock events.

Another feature of the tank design is a physical means by which the sensor subassembly 120 is held in the correct position while the bond line adhesive fully cures. Once the bond line adhesive is cured the physical means provides rigidity to the entire sensor 116 and tank structure 110, which can minimize the stress being applied to the bond line during changes in temperature and vibrational loads. The physical means can include a fastener, such a snapping mechanism 108, a clasp, a latch, threaded mechanism, or other attachment mechanism. Any suitable attachment method can be used as long as the method holds the sensor 116 in place against the features defining the bond line 118.

The tank 100 may include a focus tube 110 or measuring tube that is integrally formed with the tank 100 or inserted into tank 100 during the tank manufacturing process. The focus tube 110 can extend from one wall section of the tank toward another wall section of the tank to improve detection of a correct fluid level or fluid concentration by the ultrasonic sensor 116. In another embodiment, the focus tube 110 may only extend a portion of the height of the tank 100. The focus tube 110 may be used depending on the application and the specific sensor use regarding level measurement at various incident angles. For example, if the tank 100 is to subject to moderate angles, such as 6° to 15°, during operation then the focus tube 110 can improve the ultrasonic sensor's capability to determine a fluid level. The focus tube 110 can include at least one vent 162, such as a vent at the bottom portion of the focus tube 110, to allow fluid to flow in and out of the focus tube 110 from the tank 100. The vent 162 to allows the fluid within the focus tube 110 to self-level match the fluid that within the remainder of the tank 110 by either filling the focus tube 110 when the height of the fluid level of the tank 100 is above the fluid level of the focus tube 110 or draining the fluid in the focus tube 110 when the height of the fluid level of the tank 100 is below the fluid level of the focus tube 110.

A top portion of the focus tube 110 can include an angled surface 160 to reduce interference due to ultrasonic signals bouncing off the surface of the focus tube 110, which interference can prevent accurate sensing of the surface of the fluid being measured. Reflected sound waves can bounce off a top surface of the focus tube 110 if top surface of the focus tube 110 is parallel to the fluid surface. The reflection off the top parallel surface of the focus tube 110, which includes an ultrasonic signal traveling back up to the surface of the fluid and returning back down the focus tube 110, creates interference by canceling out the ultrasonic signal reflected off the surface of the fluid, particularly at low fluid levels when the ultrasonic sensor 116 is operating in a near field mode, as described and taught by U.S. Pat. No. 6,573,732 to Reimer, entitled “Dynamic Range Sensor and Method of Detecting Near Field Echo Signals,” with a patent date of Jun. 3, 2003, which is herein incorporated by reference in its entirety. The cancellation effect due to a reflection of a focus tube surface can be referred to as echo cancellation. An angled focus tube surface or an angled focus tube mitigates echo cancellation by causing the sound waves to bounce off at angles different from the primary sound waves used in level sensing, which disperses the energy elsewhere within the tank so the reflected energy has minimal effect to a level sensing measurement. Although, an angled surface to the focus tube 110 is shown, other configurations, such as a rounded, saw tooth, or castle shape, may also be used to disperse or deflect any sound waves reflecting off of the top of the focus tube 110.

In another configuration, a focus tube can extend upwards near the top of the tank 100. In another example, a focus tube can extend upwards to the top of the tank 100 with a float specifically designed to reflect ultrasonic signals may be used in off highway vehicles where operation at 45 degree incident angles can occur. The focus tube 110 can be molded into the interior of the tank 100, 100A, and 100B or the focus tube 110 can be inserted into the tank as a separate component through an existing opening or as a feature built into a fuel module, as shown and described in U.S. Pat. No. 8,302,472 to Rumpf, entitled “Fuel Delivery Unit with a Filling Level Sensor Operating with Ultrasonic Waves,” with a patent date of Nov. 6, 2012, which is herein incorporated by reference in its entirety.

The ultrasonic sensing system and ultrasonic sensor fabrication process described herein can begin with an existing tank molding process used to fabricate tanks. The variability of the tank wall thickness of the wall 102 of a tank 100 can change the resonant characteristics of the ultrasonic sensor 116. For example, the ultrasonic sensor 116 including a tank 100 with a thicker or thinner tank wall from a nominal tank design may still resonant but the ring time response may be over damped. The ultrasonic sensor 116 (with thicker or thinner walls) having the over damped ring time response can utilize more energy than a ultrasonic sensor with a tank wall having a nominal designed thickness in order to generate and receive an ultrasound echo that is reliable under extremes of temperature, inclination angle, and vibration. The calibration and programming of the ultrasonic sensor 116 can be used to compensate for the variably of the tank wall used to form the ultrasonic sensor 116.

Since the ultrasonic sensing system including both the tank 100 and sensor subassembly 120 is independent of tank shape or fluid application, the output of sensor 116 has to be corrected for the tank design or fluid application using a strapping table that maps the raw sensor data against a predefined table of values to extrapolate fluid level for the particular tank shape and fluid being measured. The raw sensor data can include temperature corrected time of flight (TOF) data generated by the round trip emission, reflection, and detection of the ultrasonic wave. For example, the strapping table can include an X-Y table, where the size is dependent on a desired resolution. One axis can represent temperature and another axis can represent timer values or counts representative of the time of flight, as measured by the microcontroller. For instance, the temperature axis may have steps with 7.81 C increments ranging from −40 C to 85 C and the time of flight axis may have steps with 31.25 microsecond (μsec) increments ranging from 0 to 1000 μsecs. For this example, the result is a 512 element table capable of operating over an expected range of temperatures and fuel measurements for tanks up to 500 mm deep. The table axes may use binary representations of the equivalent values of temperature or TOF (e.g., a microcontroller internal timer) as measured by an analog to digital (A/D) converter instead of temperature values in degrees C. or time values in μsecs. Each table elements can be populated with a digital representation of an expected output for that specific temperature and time of flight. A microcontroller can then use the conditioned time of flight and temperature to find the bordering table values from which the microcontroller then performs a two axis interpolation function to arrive at a correct output value.

The strapping table can be customized for the tank design and the fluid to be measured in the tank. The strapping table can be loaded into a module external (e.g., local fuel system controller or an electronic control unit (ECU) for a fuel tank) to the tank 100 in applications where a strapping module exist and is separate from the sensor subassembly 120, or the strapping table can be loaded or downloaded into the circuitry of sensor subassembly (e.g., microcontroller) prior to or following assembly into the tank 100. When the strapping table is loaded or downloaded into the circuitry of the sensor subassembly 120, an output operating mode can be included in the circuitry allowing serial communication of the sensor data through an electrical connector (e.g., integral connector) regardless of the type of sensor output desired.

For example, a user may desire a simple resistive output emulation, which can be selected by the strapping table data, where the sensor changes the load current and voltage at the electrical connector terminals in proportion to the measured level, which can be a normal mode of operation of the ultrasonic sensor 116. In a first operating mode (e.g., normal operating mode), the sensor measures the level of the fluid and performs basic diagnostic functions to insure that the sensor is providing correct measurement information. A second operating mode can include a fault mode of operation where the sensor 116 detects an issue with the returned echo quality, temperature measurement, or some other internal function and can then provide an output indicative of the fault that was detected. Other operating modes (e.g., self-test, programming, and calibration operating modes) can use the same electrical connector terminals as a serial bi-directional data link through which an external computer can be used to program a strapping table into the sensor subassembly circuitry and provide means by which the circuitry can communicate diagnostic data to facilitate a self-test sequence. For example, a third mode of operation can include an initial self-test sequence occurring following assembly of the sensor subassembly 120 into the tank 100. In this self-test mode of operation, the sensor 116 measures the ring-time of the piezo element at various power levels within a dry tank. These measurements can be uploaded to an external host computer and/or test station and based on the measurements the host computer determines if the results were acceptable or not acceptable for that particular tank 100, which can be used as part of quality control to reject tanks 100 improperly bonded with the sensor subassembly 120. The fourth mode of operation can include the calibration mode where the host computer downloads the strapping table values as determined for the specific tank, size, shape, fluid type, and output desired. The third and fourth modes of operation may include a disabling or lockout mechanism, which may be activated by the host computer, to prevent the sensor 116 from being changed after self-testing, programming, or calibration, such as when the tank assembly leaves the factory.

A similar process can be used for ultrasonic sensors designed with a pulse-width modulation (PWM) output, voltage output, current loop, and any serial data outputs, such as single edge nibble transmission (SENT) protocol, local interconnect network (LIN) protocol, controller area network (CAN) protocol, or another custom serial data protocols. PWM is a modulation technique that controls the width of the pulse (or pulse duration) based on modulator signal information. Society of Automotive Engineers (SAE) J2716 SENT is a point-to-point protocol for transmitting signal values from a sensor to a controller that allows for high resolution data transmission with a lower system cost than other serial data protocols. The SENT protocol is a one-way, asynchronous voltage interface which uses three wires: a signal line with a low state less than 0.5 volts (V) and a high state greater than 4.1V, an approximately 5V supply voltage line, and an approximately 0V ground line. For example in the SENT protocol, data are transmitted in units of 4 bits (1 nibble) and a SENT message is 32 bits long (8 nibbles) and includes 24 bits of signal data (6 nibbles) that represents 2 measurement channels of 3 nibbles each (such as pressure and temperature), 4 bits (1 nibble) for cyclic redundancy check (CRC) error detection, and 4 bits (1 nibble) of status/communication information. SENT is a low cost solution that can convey measurement information as well as diagnostic information. CAN is a vehicle bus standard designed to allow microcontrollers and devices to communicate with each other within a vehicle without a host computer. The CAN protocol uses a two-wire bus priority based scheme. LIN is a serial network protocol used for communication between components in vehicles. The LIN protocol uses a one-wire daisy-chain or bus with a shunt master-slave topology.

In another embodiment, the strapping table data is programmed into the sensor subassembly circuitry via the wireless component or device or diagnostic data from the sensor subassembly circuitry is obtained via the wireless component or device.

Since the coupling or bonding of the sensor subassembly 120 to the tank wall 102 can be performed at a facility (e.g., tank molding facility) different from the facility manufacturing the sensor subassembly, the sensor subassembly 120 can include features and programming to provide self-testing of the assembled ultrasonic sensor 116 (including the tank wall 102). The assembled ultrasonic sensor 116 can be tested for a particular type of fluid, even without filling the tank 100 with that fluid. Testing the sensor by filling the tank with a quantity of fluid and then comparing the output to the specified value can be very time consuming, difficult, and possibly dangerous depending on the particular fluid in a production environment. Self-testing of the ultrasonic sensor 116 can avoid these challenges. Self-testing can compare dry tank values that correspond to acceptable values for a particular type of fluid and tank design, which can be generated using a prototype of the tank design and the fluid used. As a result of the self-testing functionality, the tank molding operation where sensor subassemblies 120 are assembled to the tank 100 may not have to have the ultrasonic sensor knowhow on site to help diagnose complex problems, maintain sensitive processes, or evaluate whether the sensor is working correctly. The sensor subassembly circuitry via a testing device can verify that the ultrasonic sensor 116 is functioning correctly for the specific application, tank, or fluid. The sensor 116 can perform a self-test following assembly into the tank 100, which can occur in close succession to the time during which the strapping table is being programmed into the sensor 116. By combining these two activities (e.g., self-testing and programming), the sensor 116 can have a cable plugged into the electrical connector (e.g., integral connector 124, 126, and 128) a single time for both testing and programming, which can save assembly time and labor, thus reducing the cost of assembling the ultrasonic sensor 116.

An ultrasonic sensor 116 as a resonant system has a certain ring time response dependent on the applied energy used to stimulate the piezo layer 130. Self-testing maps the ring time response of the sensor 116 when assembled into the tank 100 that exposed to ambient conditions (e.g., room temp and air) at one or more power levels. The time that the sensor 116 takes for the piezo layer 130 to stop ringing at a particular power level is proportional to the quality factor (Q, Q factor, or Quality) of the resonant acoustic circuit. The quality factor is a dimensionless parameter that describes damping an oscillator or resonator or equivalently characterizes a resonator's bandwidth relative to the resonator's center frequency. A higher Q indicates a lower rate of energy loss relative to the stored energy of the resonator, where the oscillations die out more slowly. Measuring these ring time values at various power levels can provide a reasonably accurate picture of how well the transducer 116 is functioning within the tank 100 without having to fill the tank with fluid.

The sensor subassembly 120 when entering into the self-test mode of operation can measure the ring time at one or more power levels and broadcast the ring time though the serial bi-directional data link (via the electrical connector) to an external test and programming device (e.g., computer). The external computer can then compare the measured ring times against an acceptance table uniquely derived for the particular tank integration. The acceptance table can include threshold ring time values indicating proper functionality of the ultrasonic sensor for a particular tank and fluid. In an embodiment, the acceptance table can be stored on the external computer in conjunction with the strapping table for a specific tank design. Each unique tank design can have a differing resonant profile. By storing the expected resonant profile for a particular tank design on an external test computer along with the strapping table can result in a sensor that is relatively independent of tank design, so a common and less costly ultrasonic sensor subassembly 120 can be broadly applied across multiple tank designs and assembled to a tank 100 by the tank manufacturer.

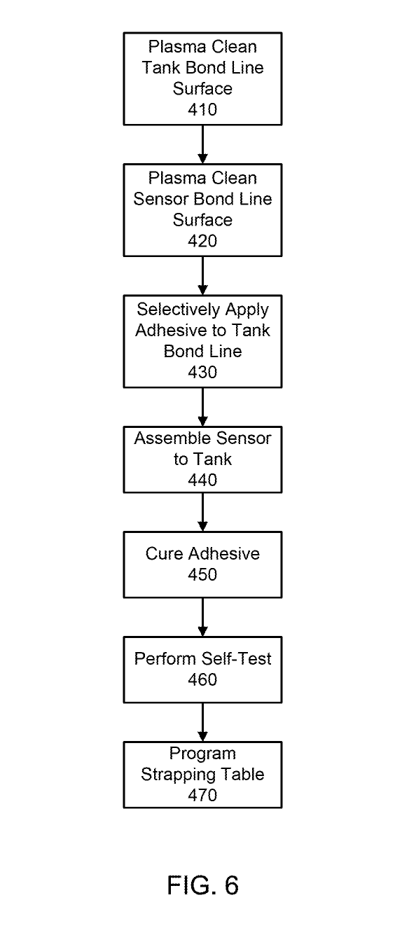

FIG. 6 illustrates a process that can be used to assemble or couple the sensor subassembly 120 to a tank wall 102 of a tank 100. The tank 100 in the process can include features such as the bond line surface and sensor subassembly receptacle already formed in the tank wall 102 during the tank fabrication or molding process. Alternatively, etching of the bond line surface on the tank wall 102 can occur after the tank 100 has been fabricated. The bond line surface of the tank 100 is plasma cleaned from contaminants to improve adhesion of the piezo layer 130 of the sensor subassembly 120 with the tank wall 102, as in block 410. The cleaning includes energizing the surface material of the tank to insure adhesion of the tank to the piezo layer. Various methods for cleaning and energizing the surface material can include plasma cleaning, mechanical etching, or use of a primer. For example, plasma cleaning involves the removal of impurities and contaminants from surfaces through the use of an energetic plasma or dielectric barrier discharge (DBD) plasma created from gaseous species. Gases such as argon and oxygen, as well as mixtures such as air and hydrogen or nitrogen are used. The plasma is created by using high frequency voltages (e.g., kilohertz (kHz) to greater than megahertz (MHz)) to ionize the low pressure gas. The bond line surface of the piezo layer 130 of the sensor 116 is cleaned from contaminants, as in block 420.

An adhesive can be selectively applied to the bond line surface of the tank 100, as in block 430. In other examples, the adhesive can be selectively applied to the bond line surface of the piezo layer 130. The sensor subassembly 120 can be aligned, coupled, or assembled to the tank 100 to form an ultrasonic sensor 116, as in block 440. The alignment can be provided by the matching or corresponding structures of the sensor subassembly 120 and sensor subassembly receptacle along with any fasteners 108 and 148. The fasteners can apply pressure on the piezo layer 130 against the tank wall 102 while the adhesive cures, as in block 450. The sensor subassembly circuitry performs a self-test via an external computer (e.g., testing computer) to verify the ultrasonic sensor functionality for the specific tank design and fluid to be used, as in block 460. The external computer (e.g., programming computer) can also program the sensor subassembly circuitry with a strapping table that can map raw sensor data to a usable fluid level or fluid concentration, as in block 470.

As can be shown in the flow chart of FIG. 6, the process for assembling the sensor subassembly 120 into a tank wall 102 of a tank 100 (e.g., a fuel tank), testing the sensor 116, and programming the strapping table is a compact process requiring minimal equipment, space, and ultrasonic sensor processing knowhow, which can be performed by a tank manufacturer. Parameters affecting the operation of the sensing system, such as ultrasonic transducer sensitivity, angle performance, level accuracy, resolution, temperature performance, ease of assembly and reliability can be a function of the design, material selection, and the two bond-line cleaning operations described previously. Assembling the sensor subassembly 120 into a tank wall 102 of a tank 100, testing the ultrasonic sensor 116, or programming the ultrasonic sensor 116 can use the methods shown, described, and taught by U.S. Pat. No. 6,573,732 to Reimer, entitled “Dynamic Range Sensor and Method of Detecting Near Field Echo Signals,” with a patent date of Jun. 3, 2003, which is herein incorporated by reference in its entirety, U.S. Pat. No. 8,733,153 to Reimer, et al., entitled “Systems and Methods of Determining a Quality and/or Depth of Diesel Exhaust Fluid,” with a patent date of May 27, 2014, which is herein incorporated by reference in its entirety, and pending U.S. patent application Ser. No. 14/286,572 to Reimer, et al., entitled “Systems and Methods of Determining a Quality and Quantity of a Fluid,” with a filing date of May 23, 2014, which is herein incorporated by reference in its entirety.

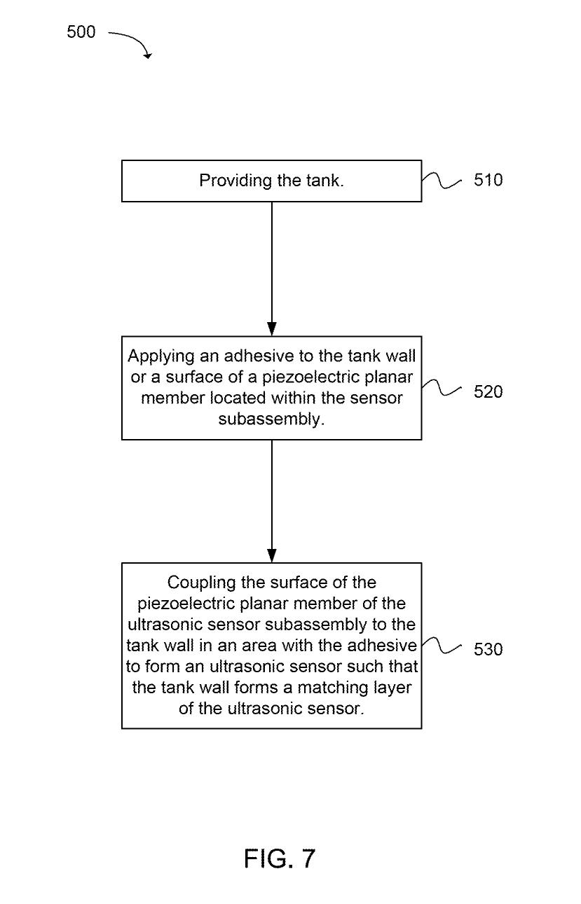

Another example provides a method 500 for bonding an ultrasonic sensor subassembly to a tank wall of a tank to form an ultrasonic sensor, as shown in the flow chart in FIG. 7. The method includes the operation of providing the tank 100, as in block 510. The operation of applying an adhesive to the tank wall 102 or a surface of a planar piezoelectric element 130 located within the sensor subassembly 120 follows, as in block 520. The next operation of the method is coupling the surface of the planar piezoelectric element 130 of the ultrasonic sensor subassembly 120 to the tank wall 102 in an area with the adhesive to form an ultrasonic sensor 116 such that the tank wall 102 forms a matching layer of the ultrasonic sensor 116, as in block 530.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. An ultrasonic sensor subassembly configured to form an ultrasonic sensor upon coupling to a tank having a tank wall, the ultrasonic sensor subassembly comprising:
a sensor subassembly housing;
a planar piezoelectric element located within the sensor subassembly housing, the planar piezoelectric element including a surface configured to couple to the tank wall such that the tank wall forms a matching layer of the ultrasonic sensor; and
circuitry electrically connected to the planar piezoelectric element, the circuitry configured to produce a signal to drive the planar piezoelectric element to generate a sound wave, and receive an indication of a detected echo from the planar piezoelectric element.

2. The ultrasonic sensor subassembly of claim 1, wherein the coupling of the surface of the planar piezoelectric element to the tank wall includes bonding.

3. The ultrasonic sensor subassembly of claim 1, wherein the tank is configured for a motorized vehicle or equipment including an automobile, motorcycle, motor vehicle, watercraft, or aircraft, and the tank is configured to store fuel, gasoline, diesel, oil, coolant, diesel exhaust fluid (DEF), brake fluid, transmission fluid, windshield washer fluid, fresh water, gray water, or black water.

4. The ultrasonic sensor subassembly of claim 1, wherein the circuitry configured to produce a signal to drive the planar piezoelectric element includes a printed circuit board (PCB) or a system on chip (SoC).

5. The ultrasonic sensor subassembly of claim 1, further comprising:
a temperature sensor electrically connected to the circuitry configured to detect a temperature of a fluid in the tank.

6. The ultrasonic sensor subassembly of claim 1, wherein the circuitry is configured to verify the coupling between the tank wall and the planar piezoelectric element of the ultrasonic sensor, or the circuitry is configured to extrapolate a fluid level for a specified tank design and a type of fluid being measured using a strapping table that maps an output from the ultrasonic sensor against a predefined table of values.

7. The ultrasonic sensor subassembly of claim 1, further comprising:
an integral connector or a wire harness electrically coupled to the circuitry, the integral connector or the wire harness configured to interface with a testing device or a programming device, wherein
the testing device is configured to test the ultrasonic sensor formed by at least the planar piezoelectric element of the ultrasonic sensor subassembly and the tank wall; and
the programming device is configured to program the circuitry of the ultrasonic sensor subassembly with a strapping table for a specified tank design that defines an output from the ultrasonic sensor for a given temperature and measured time of flight.

8. The ultrasonic sensor subassembly of claim 1, further comprising:
a second matching layer coupled to a surface of the planar piezoelectric element opposite the surface that is configured to be coupled to the tank wall;
leads electrically coupling each planar surface of the planar piezoelectric element to the circuitry;
a piezo potting material to support the leads and movement of the planar piezoelectric element in the sensor subassembly housing;
a cover to protect the circuitry and the planar piezoelectric element from external environmental conditions; or
a printed circuit board (PCB) potting material to support or protect the circuitry.

9. The ultrasonic sensor subassembly of claim 1, wherein the ultrasonic sensor is configured to measure a fluid concentration, measure a fluid level, or provide a diagnostic mode of operation.

10. A tank coupled to an ultrasonic sensor subassembly, comprising:
a tank having a tank wall; and
an ultrasonic sensor subassembly comprising:
a sensor subassembly housing;
a planar piezoelectric element located within the sensor subassembly housing, the planar piezoelectric element including a surface coupled to a tank wall such that the tank wall forms a matching layer of an ultrasonic sensor; and
circuitry electrically connected to the planar piezoelectric element, the circuitry configured to produce a signal to drive the planar piezoelectric element to generate a sound wave, and receive an indication of a detected echo from the planar piezoelectric element.

11. The tank of claim 10, wherein the tank wall forms a sensor subassembly receptacle to mate with the sensor subassembly housing and aligns the tank wall with the surface of the planar piezoelectric element, and the sensor subassembly receptacle includes a mechanism to fasten the sensor subassembly housing to the tank.

12. The tank of claim 11, wherein the tank includes stiffening ribs on a perimeter of the sensor subassembly receptacle.

13. The tank of claim 10, wherein the tank wall is configured to pass ultrasonic energy and includes at least three spacers defining a uniform planar surface of the matching layer, spacers are configured to maintain a substantially uniform bond line between the planar piezoelectric element and the tank wall.

14. The tank of claim 13, wherein each spacer is columnar, pyramidal, or dome-like.

15. The tank of claim 13, wherein the substantially uniform bond line has a substantially constant thickness controlled by a height of the spacers.

16. The tank of claim 10, wherein the tank includes focus tube within the tank, the focus tube extending from a lower wall section of the tank upwards towards an upper wall section of the tank, wherein the planar piezoelectric element is coupled to a surface of the tank wall that is on an opposite side of the tank wall to an area within the focus tube.

17. The tank of claim 16, wherein a plane or a surface formed by an upper end of the focus tube is nonparallel with respect to the fluid plane.

18. The tank of claim 16, wherein the tank includes a focus tube float confined by the focus tube.

19. A method of bonding an ultrasonic sensor subassembly to a tank wall of a tank to form an ultrasonic sensor, comprising:
providing the tank;
applying an adhesive to the tank wall or a surface of a planar piezoelectric element located within the sensor subassembly; and
coupling the surface of the planar piezoelectric element of the ultrasonic sensor subassembly to the tank wall in an area with the adhesive to form an ultrasonic sensor such that the tank wall forms a matching layer of the ultrasonic sensor.

20. The method of claim 19, further comprising, before applying the adhesive:
cleaning a surface the tank wall; or
cleaning the surface of the planar piezoelectric element.

21. The method of claim 19, further comprising:
curing the adhesive.

22. The method of claim 19, further comprising:
testing the ultrasonic sensor to verify a bond between the tank wall and the surface of the planar piezoelectric element.

23. The method of claim 22, wherein testing the ultrasonic sensor further comprises:
coupling the ultrasonic sensor subassembly to a testing device via an integral connector;
stimulating the ultrasonic sensor to measure the ring time at multiple power levels;
receiving measured the ring time responses at multiple power levels from the ultrasonic sensor;
and
comparing the measured ring time responses against specified threshold values in an acceptance table for a specified tank design to verify that the ring time responses of the ultrasonic sensor fall within the specified threshold values indicating a functioning ultrasonic sensor for the specified tank design.

24. The method of claim 19, further comprising:
programming circuitry of the ultrasonic sensor subassembly with a strapping table that maps a measured time of flight (TOF) of a detected sound wave and temperature against a predefined table of values to extrapolate a level output for a specified tank design and a type of fluid being measured.

25. The method of claim 24, wherein the strapping table factors for a tank, a tank size, a tank shape, and type of fluid.
